(19) United States
(12) Patent Application Publication
(10) Pub. No.: US 2013/0227149 A1
(43) Pub. Date: Aug. 29, 2013

(54) METHOD FOR PROVIDING A COMMUNICATION SESSION AND DEVICE

(71) Applicants: Phani Bhushan Athlur, Bangalore (IN); Prabhakar Krishnaswamy, Bangalore (IN)

(72) Inventors: Phani Bhushan Athlur, Bangalore (IN); Prabhakar Krishnaswamy, Bangalore (IN)

(73) Assignee: Intel Mobile Communications GmbH, Neubiberg (DE)

(21) Appl. No.: 13/773,813

(22) Filed: Feb. 22, 2013

(30) Foreign Application Priority Data
Feb. 24, 2012 (IN) 187/KOL/2012

(51) Int. Cl. H04L 29/08

(52) U.S. Cl. CPC H04L 67/14
USPC 709/227

(57) ABSTRACT

A method for providing a communication session may include establishing, during an established communication session between a first communication device and another communication device, a communication connection with a second communication device; determining, as to whether one or more communication services provided in the communication session by the first communication device should be provided by the second communication device; and in case at least one of the communication services provided in the communication session should be provided by the second communication device, establishing a communication session connection for the at least one communication service of the communication session, and providing the at least one communication service by the second communication device within the established communication session.

### CROSS-REFERENCE TO RELATED APPLICATION

This application claims priority to Indian Patent Application Serial No. 187/KOL/2012, which was filed Feb. 24, 2012, and is incorporated herein by reference in its entirety.

### TECHNICAL FIELD

The present disclosure relates to a method for providing a communication session and a device.

### SUMMARY

A method for providing a communication session may include establishing, during an established communication session between a first communication device and another communication device, a communication connection with a second communication device; determining, as to whether one or more communication services provided in the communication session by the first communication device should be provided by the second communication device; and in case at least one of the communication services provided in the communication session should be provided by the second communication device, establishing a communication session connection for the at least one communication service of the communication session, and providing the at least one communication service by the second communication device within the established communication session.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various aspects of the disclosure. In the following description, various aspects of the disclosure are described with reference to the following drawings, in which:

FIG. 1 shows a flow diagram illustrating a method for providing a communication session in accordance with various aspects of the disclosure;

FIG. 2 shows a communication system in accordance with various aspects of the disclosure;

FIG. 3 shows a communication device in accordance with various aspects of the disclosure;

FIG. 4 shows a communication device in accordance with various aspects of the disclosure;

FIG. 5 shows a communication system in accordance with various aspects of the disclosure;

FIG. 6 shows a communication system in accordance with various aspects of the disclosure;

FIG. 7 shows a communication system in accordance with various aspects of the disclosure;

FIG. 8 shows a communication system in accordance with various aspects of the disclosure;

FIG. 9 shows a communication system in accordance with various aspects of the disclosure;

FIG. 10 shows a first rule file and a second rule file in accordance with various aspects of the disclosure;

FIG. 11 shows a user interface to set up rules in the rule files and to set capabilities of a respective communication device;

FIG. 12 shows a message flow diagram in accordance with various aspects of the disclosure;

FIG. 13 shows a message flow diagram in accordance with various aspects of the disclosure; and

FIG. 14 shows a message flow diagram in accordance with various aspects of the disclosure.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

A “circuit” may be understood as any kind of a logic implementing entity, which may be hardware, software, firmware, or any combination thereof. Thus, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be software being implemented or executed by a processor, e.g. any kind of computer program, e.g. a computer program using a virtual machine code such as, e.g. Java. Any other kind of implementation of the respective functions which will be described in more detail below may also be understood as a “circuit”.

The terms “coupling” or “connection” are intended to include a direct “coupling” or direct “connection” as well as an indirect “coupling” or indirect “connection” respectively.

The term “protocol” is intended to include any piece of software and/or hardware, that is provided to implement part of any layer of the communication definition. “Protocol” may include the functionality of one or more of the following layers: physical layer (layer 1), data link layer (layer 2), network layer (layer 3), or any other sub-layer of the mentioned layers or any upper layer.

The communication protocol layers and its respective entities which will be described in the following may be implemented in hardware, in software, in firmware, or partially in hardware, and/or partially in software, and/or partially in firmware. One or more communication protocol layers and its respective entities may be implemented by one or more circuits. At least two communication protocol layers may be commonly implemented by one or more circuits.

The term “communication service” is intended to include any type of media communication connection provided at a specific operating parameter set. By way of example, a “communication service” may include a video communication service using a specific video encoding/decoding algorithm or standard (e.g. MPEG 2, MPEG 4, MPEG 7, H.261, ITU H.263, ITU H.264, etc.) with specific operating parameters (such as resolution, allowed delay, data rate, etc.). Furthermore, by way of example, a “communication service” may also include a voice call (or audio) communication service using a specific audio encoding/decoding algorithm or standard (e.g. ITU G.711, Adaptive Multi-Rate Narrowband (AMR-NB), Adaptive Multi-Rate Wideband (AMR-WB), Advanced Multi-Band Excitation (AMBE), etc.) with specific operating parameters (such as resolution, allowed delay, data rate, etc.). Furthermore, by way of example, a “communication service” may also include a chat communication service, e.g. including encoding/decoding algorithms or standard for encoding/decoding text data. Another example of a “communication service” may include a file transfer communication service (or also file sharing communication service) or other application data transfer communication service, e.g. image data transfer communication service, etc. These communication services may be combined with each other as desired, e.g. in order to provide a gaming application communication service, a white board application communication service, an m-tutor/e-tutor communication service, etc.

Various aspects of the disclosure may provide seamless transfer of a communication service (e.g. of a Voice Call communication service (also referred to as audio communication service), Video Call communication service (also referred to as video communication service), Chat communication service (also referred to as text communication service), etc.) across a user's own set of multiple communication devices and to enrich/enhance (e.g. convert chat communication service to voice call communication service and/or to video call communication service) or shrink (e.g. convert video call communication service to voice call communication service and/or to chat communication service) based on at least one of users' preference(s), capability/capabilities of the communication device(s), proximity of the communication devices, and location of the communication devices.

Various aspects of the disclosure may seamlessly transfer a communication service (e.g. Voice Call communication service, Video Call communication service, Chat communication service, etc.) across multiple communication devices of a user and to provide options to enrich (e.g. convert voice call communication service to video call communication service) or shrink (e.g. video call communication service to voice call communication service to chat communication service) based on users' preference, capability of communication devices, proximity and location. Also, the quality of the transferred or enhanced voice call communication service or video call communication service may be modified based on capability of the devices on the fly (Normal audio/video call communication service to a High Definition (HD) audio/video call communication service). Various aspects may also offer seamless data offloading as a part of transfer and enrichment.

Various aspect may transfer or enhance communication services across user's own multiple communication devices e.g. based on communication devices' capability, proximity, location and preference.

As will be described in more detail below, various aspects of the disclosure may provide a smart communication service transfer and smart communication service enrichment amongst a user's own set of communication devices. Smart communication service transfer may involve transferring one or more chat communication services, one or more voice call communication services, one or more video call communication services, etc. across multiple communication devices. Smart communication service enrichment may involve—enhancing a communication service or shrink a communication service. The transfer and enrichment may be based on user's multiple devices' capability/capabilities, user's preference(s), location of the communication device(s) and proximity of the communication device(s).

The communication devices proximity and locations are either pre-configured or dynamically discovered on the communication network. One of the dynamic communication device discovery methods which may be used is standard Bluetooth communication device discovery method or WiFi (IEEE 802.11) communication device discovery method, a Wireless Local Area Network communication device discovery method, or any other discovery method in accordance with any other, e.g. radio, communication technology. Another dynamic communication device discovery method which may be used is the Session Initiation Protocol (SIP) NOTIFY mechanism for SIP registration-event package. The locations may be an office, a car, an apartment or house, e.g. a user's home, etc. New locations and new communication devices may be added to a trusted communication device list. Existing locations and communication devices may be removed from the trusted communication device list.

Illustratively, in various aspects of the disclosure, during a running communication session between two communication devices, one of the communication devices may choose to transfer the provision of one or more of the communication services provided within the communication session to another communication device, thereby possibly enriching or shrinking the powerfulness of the provided communication service(s), e.g. by adding or removing one or more media communication connections to provide more or less media types within the communication session, e.g. dependent on the communication device capabilities. In addition or as an alternative, the parameters (e.g. data processing rate, encoding/decoding algorithm, encoding/decoding parameters, display resolution, audio output resolution, etc.) of the provided transferred communication service(s) may be changed.

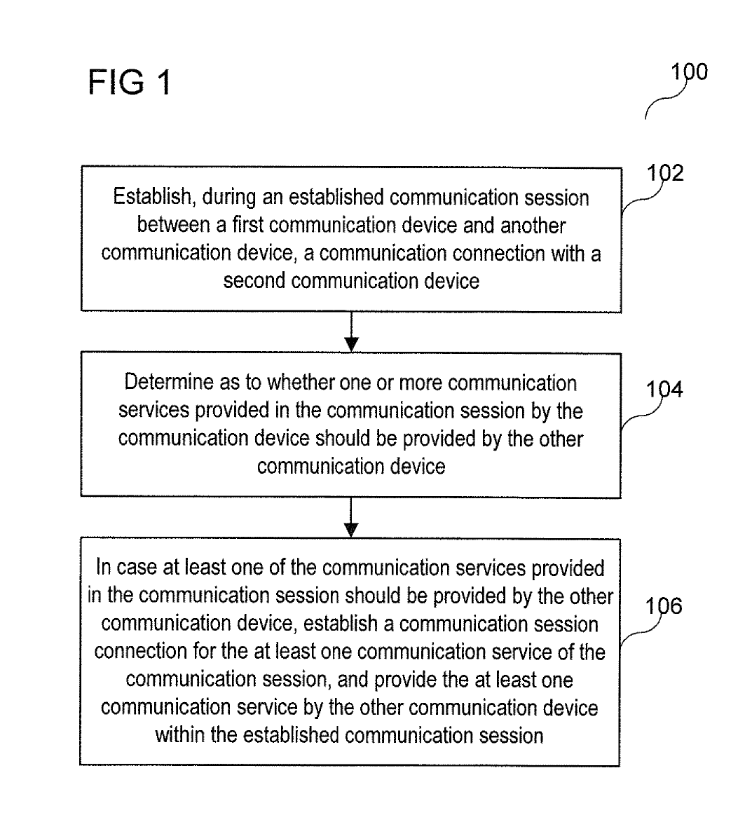

As will be described in more detail below and as shown in a flow diagram 100 in FIG. 1, a method for providing a communication session is provided. The method may include, in 102, establishing, during an established communication session between a first communication device and another communication device, a communication connection with a second communication device. The method may further include, in 104, determining, as to whether one or more communication services provided in the communication session by the first communication device should be provided by the second communication device, and, in 106, in case at least one of the communication services provided in the communication session should be provided by the second communication device, establishing a communication session connection for the at least one communication service of the communication session, and providing the at least one communication service by the second communication device within the established communication session.

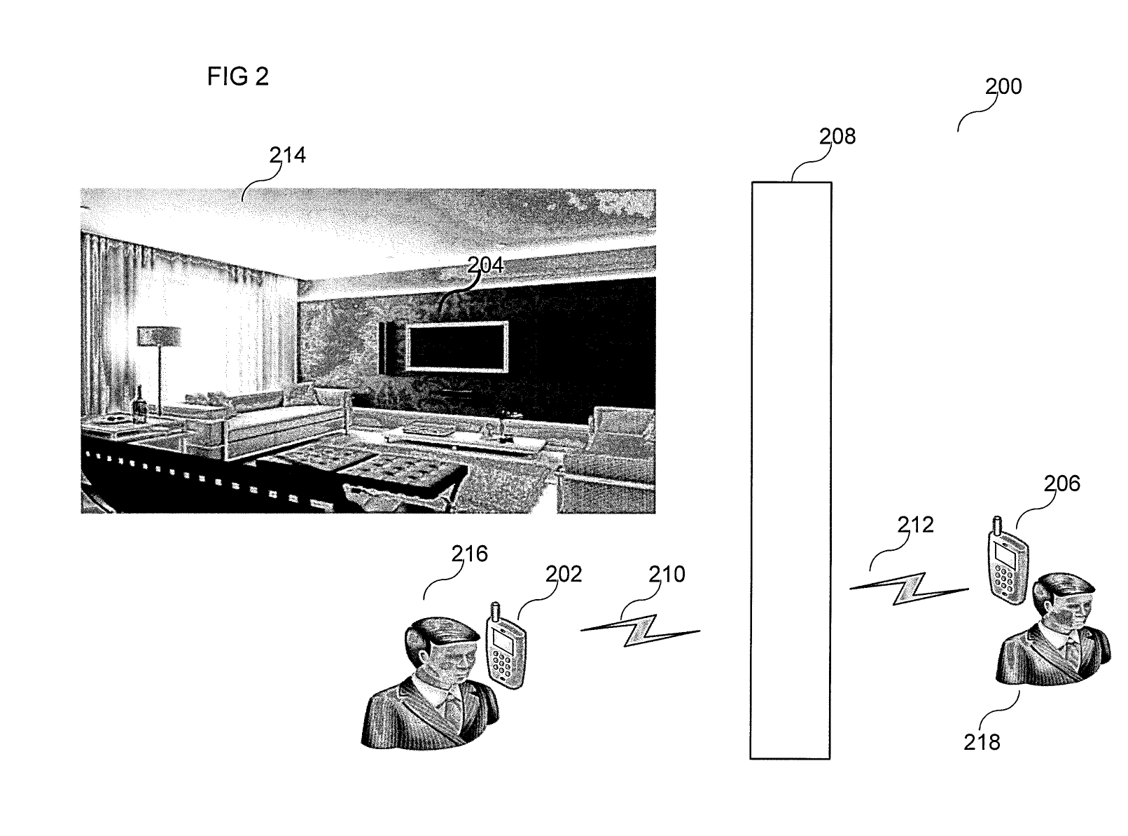

FIG. 2 shows a communication system 200 in accordance with various aspects of the disclosure.

As shown in FIG. 2, the communication system 200 may include a plurality of communication devices 202, 204, 206, e.g. a first mobile radio communication terminal device 202, a second mobile radio communication terminal device 204, and a third mobile radio communication terminal device 206. Each of the mobile radio communication terminal devices 202, 204, 206 may be any type of mobile radio communication terminal device such as e.g. a mobile radio handset, a smartphone, a notebook including a mobile radio communication module, a laptop including a mobile radio communication module, any other type of computer including a mobile radio communication module, or even a display of television device including a mobile radio communication module. Any other electronic device including a mobile radio communication module or a communication module which provides a communication session with another communication device may be provided.

Although various aspects are described in the context of an implementation in accordance with the Long Term Evolution (LTE) standard as described in 3GPP TS 36.300 v 10.3.0, it is to be noted that various implementations may also be implemented in accordance with other mobile radio communication systems such as e.g. another 3GPP mobile radio communication system (e.g. Universal Mobile Telecommunications System (UMTS)), a Code Division Multiple Access (CDMA) mobile radio communications standard, a Code Division Multiple Access 2000 (CDMA 2000) mobile radio communications standard, a Freedom of Mobile Multimedia Access (FOMA) mobile radio communications standard, or a Long Term Evolution Advanced (LTE-Advanced) mobile radio communications standard.

The air interface of an LTE mobile radio communication system, or E-UTRA (Evolved Universal Terrestrial Radio Access) is commonly referred to as ‘3.9G’, although some North American operators recently made an attempt to name their LTE service offerings ‘4G’ for marketing reasons. The first LTE release specified by 3GPP is Rel-8.

In comparison with its predecessor UMTS, an LTE mobile radio communication system in accordance with various aspects offers an air interface that has been further optimized for packet data transmission by improving the system capacity and the spectral efficiency. Among other enhancements, the maximum net transmission rate has been increased significantly, namely to 300 Mbps in the downlink transmission direction and to 75 Mbps in the uplink transmission direction. LTE supports scalable bandwidths of from 1.4 MHz to 20 MHz and is based on new multiple access methods, such as OFDMA/TDMA (Orthogonal Frequency Division Multiple Access/Time Division Multiple Access) in downlink direction (in other words, in a communication direction from a mobile radio tower, e.g. a base station or eNodeB, to a mobile radio communication terminal device, such as a handset device) and SC-FDMA/TDMA (Single Carrier Frequency Division Multiple Access/Time Division Multiple Access) in uplink direction (in other words, in a communication direction from a mobile radio communication terminal device, such as a handset device to a mobile radio tower, e.g. a base station or eNodeB). OFDMA/TDMA is a multicarrier multiple access method in which a subscriber is provided with a defined number of subcarriers in the frequency spectrum and a defined transmission time for the purpose of data transmission. The RF (radio frequency) capability of an LTE mobile radio communication terminal device, such as e.g. an LTE User Equipment (UE 32 mobile station, cell phone) for transmission and reception has been set to 20 MHz. A physical resource block (PRB) is the baseline unit of allocation for the physical channels defined in LTE. It may include a matrix of 12 subcarriers by 6 or 7 OFDMA/SC-FDMA symbols. At the physical layer a pair of one OFDMA/SC-FDMA symbol and one subcarrier is denoted as a ‘resource element’.

The LTE mobile radio communication system may include a core network, also referred to as Evolved Packet Core (EPC), which may include, inter alia, one or more Mobility Management Entities/Serving Gateways (MME/S-GW). The LTE mobile radio communication system may further include an Evolved Universal Terrestrial Radio Access Network (E-UTRAN), which may include one or more base stations, which may also referred to as Evolved NodeBs (eNBs), and one or more (in general an arbitrary number of) mobile radio communication terminal devices 202, 204, 206, which may also be referred to as User Equipments (UEs) 202, 204, 206. The entities of the core network as well as of the E-UTRAN are denoted in FIG. 2 with one common reference number 208.

As shown in FIG. 2, it is assumed that a first mobile radio communication terminal device 202 (in the following also referred to in general as first communication device 202) has an established communication session (which may be a single-media communication session, thereby providing a communication using a single media type within the communication session, or a multimedia communication session, thereby providing a communication using a plurality of media types within the communication session) with a second mobile radio communication terminal device 204 (in the following also referred to in general as second communication device 204). The established communication session is symbolized in FIG. 2 using two arrows 210 and 212, wherein a first arrow 210 symbolizes a first radio connection between the first communication device 202 and a respective eNB the first communication device 202 is camped on (registered in), and wherein a second arrow 212 symbolizes a second radio connection between the second communication device 204 and a respective eNB the second communication device 204 is camped on (registered in). In other words, a first user and subscriber 216 may be in an established communication session with a second user and subscriber 218 using the first communication device 202 and the third communication device 206.

It is to be noted, that the communication session may include more than two communication device in the same running communication session, thereby providing a communication conference session.

The communication session may include an audio communication service as well as a video communication service, in other words, one or more different media streams (e.g. one or more audio streams (e.g. mono or stereo) and/or video streams (e.g. “normal” video stream or stereoscopic video stream) may be transmitted within the communication session.

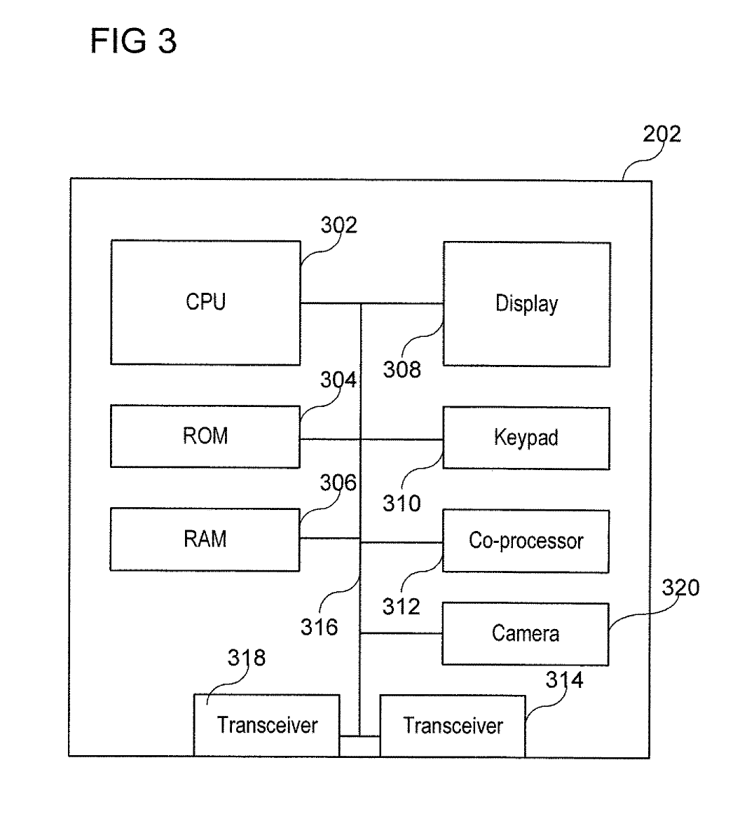

FIG. 3 shows a communication device, e.g. the first communication device 202, in accordance with various aspects of the disclosure.

As shown in FIG. 3, the first communication device 202 may be a mobile radio communication device configured in accordance with LTE and/or other 3GPP mobile radio communication technologies, as described above.

In various aspects of the disclosure, the first communication device 202 may include a processor 302, such as e.g. a microprocessor (e.g. a central processing unit (CPU)) or any other type of programmable logic device. Furthermore, the first communication device 202 may include a first memory 304, e.g. a read only memory (ROM) 304 and/or a second memory 306, e.g. a random access memory (RAM) 306. Moreover, the first communication device 202 may include a display 308 such as e.g. a touch sensitive display, e.g. a liquid crystal display (LCD) display or a light emitting diode (LED) display, or an organic light emitting diode (OLED) display. However, any other type of display may be provided as the display 308. The first communication device 202 may in addition include any other suitable output device (not shown) such as e.g. a loudspeaker or a vibration actuator. The first communication device 202 may include one or more input devices such as keypad 310 including a plurality of keys. The first communication device 202 may in addition include any other suitable input device (not shown) such as e.g. a microphone, e.g. for speech control of the first communication device 202. In case the display 308 is implemented as a touch sensitive display 308, the keypad 310 may be implemented by the touch sensitive display 308. Moreover, optionally, the first communication device 202 may include a co-processor 312 to take processing load from the processor 302. Furthermore, the first communication device 202 may include a first transceiver 314. The above described components may be coupled with each other via one or more lines, e.g. implemented as a bus 316. The first memory 304 and/or the second memory 306 may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory) or a CBRAM (Conductive Bridging Random Access Memory). The program code used to be executed and thereby to control the processor 302 (and optionally the co-processor 312) may be stored in the first memory 304. Data (e.g. the messages received or to be transmitted via the first transceiver 314) to be processed by the processor 302 (and optionally the co-processor 312) may be stored in the second memory 306. The first transceiver 314 may be configured such that it implements a Uu interface in accordance with LTE. The first communication device 202 and the first transceiver 314 may also be configured to provide MIMO radio transmission. Further, the first communication device 202 may also include an additional second transceiver 318, which may be configured such that it implements a short range radio technology, such as one as will be described in more detail below. Moreover, one or more additional transceivers (not shown in FIG. 3) may be provided, which may e.g. be configured such that it implements a Wireless Local Area Network (WLAN) technology, e.g. a Personal Area Network (PAN) technology or any other desired wireless communication technology or wireline communication technology. Moreover, the first communication device 202 may include a still image and/or video camera 320, configured to provide a video conference via the first communication device 202. Furthermore, the first communication device 202 may include a Subscriber Identity Module (SIM), e.g. a UMTS Subscriber Identity Module (USIM) or an IMS Subscriber Identity Module (ISIM) identifying a user and subscriber 216 of the first communication device 202. The processor 302 may include audio processing circuits such as e.g. audio decoding circuit and/or audio encoding circuit, configured to decode and/or encode audio signals in accordance with one or more of the following audio encoding/decoding technologies: ITU G.711, Adaptive Multi-Rate Narrowband (AMR-NB), Adaptive Multi-Rate Wideband (AMR-WB), Advanced Multi-Band Excitation (AMBE), etc.

The third communication device 206 may have a similar structure as the first communication device 202. Therefore, a repeated description of the detailed structure of the third communication device 206 will be omitted and reference is made to the description of the first communication device 202. However, it is to be noted that the first communication device 202 and the third communication device 206 may also have different structures and e.g. may or may not include one or more of the components outlined above.

Furthermore, a room 214, e.g. a living room (of course, any other room may be provided in alternative implementations), is shown in FIG. 2, wherein the second communication device 204 is located in the room 214. In this implementation, the second communication device 204 may be implemented as a television device 204 including a communication module.

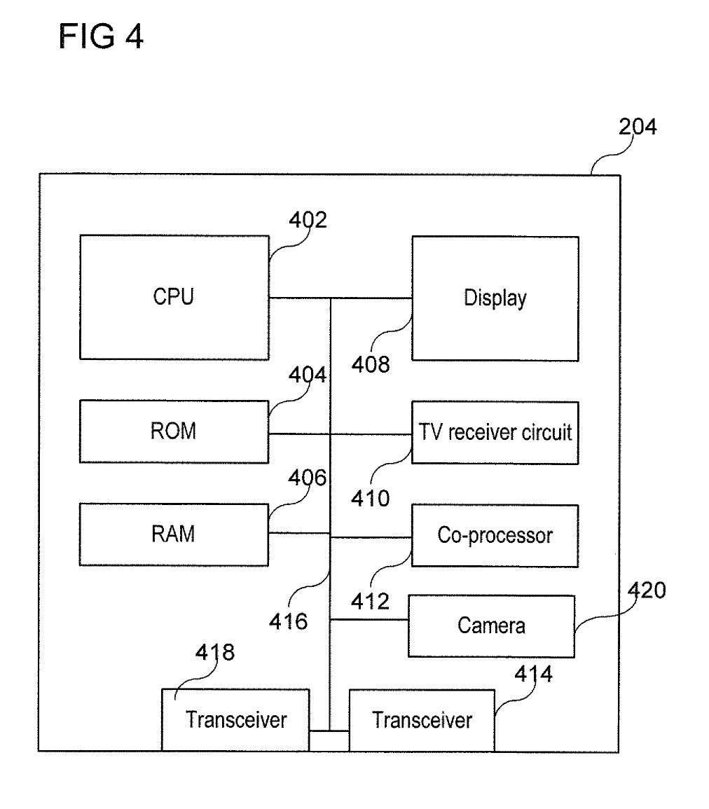

FIG. 4 shows a communication device, e.g. the second communication device 204, in accordance with various aspects of the disclosure.

In various aspects of the disclosure, the second communication device 204 may include a processor 402, such as e.g. a microprocessor (e.g. a central processing unit (CPU)) or any other type of programmable logic device. Furthermore, the second communication device 204 may include a first memory 404, e.g. a read only memory (ROM) 404 and/or a second memory 406, e.g. a random access memory (RAM) 406. Moreover, the second communication device 204 may include a display 408 such as e.g. a touch sensitive display, e.g. a liquid crystal display (LCD) display or a light emitting diode (LED) display, or an organic light emitting diode (OLED) display. However, any other type of display may be provided as the display 308. The second communication device 204 may in addition include any other suitable output device (not shown) such as e.g. a loudspeaker. The second communication device 204 may further include one or more input television (TV) receiver circuits 310 configured to receive and process TV signals. The one or more TV receiver circuits 310 may include video processing circuits such as e.g. video decoding circuit, configured to decode video signals in accordance with one or more of the following video encoding technologies: Internation Telecommunication Union (ITU) H.261, ITU H.263, ITU H.264, Moving Pictures Experts Group (MPEG, e.g. MPEG 2, MPEG 4, and MPEG 7, etc.), Sub Quarter Common Intermediate Format (SQCIF), Quarter Common Intermediate Format (QCIF), Common Intermediate Format (CIF), Video Graphics Array (VGA), 4 Common Intermediate Format (4CIF), 16 Common Intermediate Format (16CIF), High Definition (HD 720p, 1080p, etc.), etc. The second communication device 204 may in addition include any other suitable input device (not shown) such as e.g. a microphone, e.g. for speech control of the second communication device 204. Moreover, optionally, the second communication device 204 may include a co-processor 412 to take processing load from the processor 402. Furthermore, the second communication device 204 may include a first transceiver 414. The above described components may be coupled with each other via one or more lines, e.g. implemented as a bus 416. The first memory 404 and/or the second memory 406 may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory) or a CBRAM (Conductive Bridging Random Access Memory). The program code used to be executed and thereby to control the processor 402 (and optionally the co-processor 412) may be stored in the first memory 404. Data (e.g. the messages received or to be transmitted via the first transceiver 414) to be processed by the processor 402 (and optionally the co-processor 412) may be stored in the second memory 406. The first transceiver 414 may be configured such that it implements a Uu interface in accordance with LTE. The second communication device 204 and the first transceiver 414 may also be configured to provide MIMO radio transmission. Further, the second communication device 204 may also include an additional second transceiver 418, which may be configured such that it implements a short range radio technology, such as one as will be described in more detail below. Moreover, one or more additional transceivers (not shown in FIG. 4) may be provided, which may e.g. be configured such that it implements a Wireless Local Area Network (WLAN) technology, e.g. a Personal Area Network (PAN) technology or any other desired wireless communication technology or wireline communication technology. Moreover, the second communication device 204 may include a still image and/or video camera 420, configured to provide a video conference via the second communication device 202. The one or more cameras 420 may include video processing circuits such as e.g. video encoding circuit, configured to encode video signals in accordance with one or more of the following video encoding technologies: Internation Telecommunication Union (ITU) H.261, ITU H.263, ITU H.264, Moving Pictures Experts Group (MPEG, e.g. MPEG 2, MPEG 4, and MPEG 7, etc.), Sub Quarter Common Intermediate Format (SQCIF), Quarter Common Intermediate Format (QCIF), Common Intermediate Format (CIF), Video Graphics Array (VGA), 4 Common Intermediate Format (4CIF), 16 Common Intermediate Format (16CIF), High Definition (HD 720p, 1080p, etc.), etc. Furthermore, the second communication device 204 may also include a Subscriber Identity Module (SIM), e.g. a UMTS Subscriber Identity Module (USIM), or an IMS Subscriber Identity Module (ISIM) identifying a user and subscriber 216 of the second communication device 202. The processor 402 may include audio processing circuits such as e.g. audio decoding circuit and/or audio encoding circuit, configured to decode and/or encode audio signals in accordance with one or more of the following audio encoding/decoding technologies: ITU G.711, Adaptive Multi-Rate Narrowband (AMR-NB), Adaptive Multi-Rate Wideband (AMR-WB), Advanced Multi-Band Excitation (AMBE), etc.

In case the user and subscriber 216 of the first communication device 202 and the second communication device 204, the first communication device 202 and the second communication device 204 may be considered to form a trusted Personal Area Network.

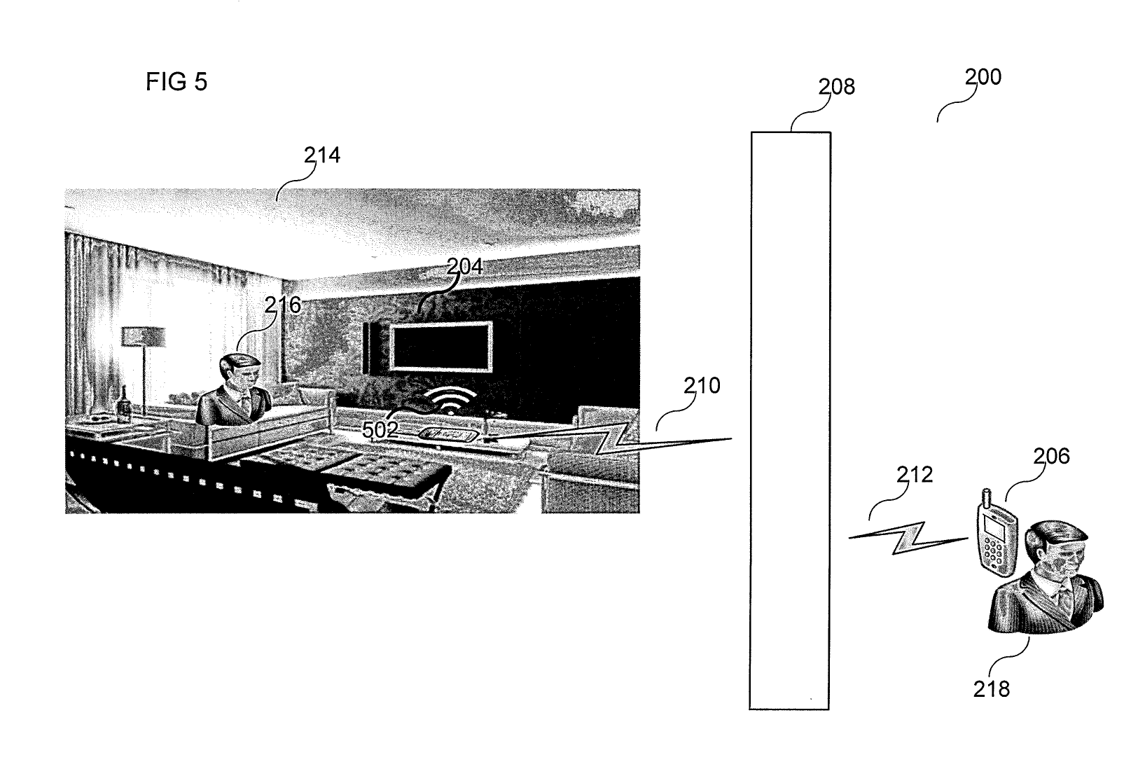

As shown in FIG. 5 the user 216 enters the room 214. It is assumed that the short range transceiver 318 of the first communication device 202 and the short range transceiver 418 of the second communication device 204 are activated so that they are scanning their environment for other short range radio devices and, upon finding one, starting the procedure to establish a short range radio connection 502 between the respective communication devices, e.g. between the first communication device 202 and the second communication device 204. Thus, in case the first communication device 202 enters the scanning region of the second communication device 204, a short range radio connection 502 between the first communication device 202 and the second communication device 204 will automatically be established.

Some possible short range radio communication technologies which may be provided in various implementations are listed as follows:
a personal area networks (Wireless PANs) radio communication sub-family, which may include e.g. IrDA (Infrared Data Association), Bluetooth, UWB, Z-Wave and ZigBee; and
a wireless local area networks (W-LANs) radio communication sub-family, which may include e.g. HiperLAN/2 (HIgh PErformance Radio LAN; an alternative ATM-like 5 GHz standardized technology), IEEE 802.11a (5 GHz), IEEE 802.11g (2.4 GHz), IEEE 802.11n, and IEEE 802.11VHT (VHT=Very High Throughput).

The frequent mentioning of non-cellular (short range) radio technologies, such as Bluetooth or WiFi (Wireless LAN, based on the “IEEE 802.11” family of standards), throughout the present disclosure does not mean a general restriction to these two typical types of (short range) radio technologies. Any type of (short range) radio technologies may be provided.

Thus, a short range communication connection 502 may be established between the first communication device 202 and the second communication device 204.

Then, as will be described in more detail below, information about the second communication device's capabilities will be provided from the second communication device 204 to the first communication device 202. The first communication device 202 may, upon receipt of the second communication device's capability information, determine as to whether it may be appropriate to provide one or more communication services provided in the communication session by the first communication device 202 up to that moment by the second communication device 204. In this implementation, it is assumed that the TV screen display 408 of the second communication device 204 provides a better resolution and video quality than the first communication device 202. After having determined this, e.g. using the received second communication device's capability information, the first communication device 202 (e.g. the processor 302 of the first communication device 202) may decide to establish a video connection between the first communication device 202 and the second communication device 204 and transfer a video communication service from the first communication device 202 to the second communication device 204 (via the first communication device 202) while keeping the communication session running and while keeping the audio communication service provided by the first communication device 202. As an alternative, e.g. the first communication device 202 may decide to transfer all communication services to the second communication device 204. The second communication device 204 may thus provide the video communication service using other communication service parameters (e.g. other display resolution, other encoding/decoding algorithms or parameters) than the first communication device 202.

Furthermore, it should be noted that in yet another implementation, the transferred communication service(s) may be provided by the second communication device 204, but no longer via the first communication device 202, but via e.g. another communication connection (within the same communication session, using e.g. the same communication session identifier (ID)) with the third communication device 206 (not shown in the figures), e.g. via a WLAN access point which may connect to the respective eNB and/or the core network of the mobile radio wide area cellular network 208.

Furthermore, it may be possible that the first communication device 202 does not provide a video communication service within the communication session with the third communication device 206. In this case, the second communication device 204 may establish a video communication connection with the third communication device 206 to thus provide (and add) a video communication service within the already running communication session.

If the first user and subscriber 216 and thus the first communication device 202 leaves the range of coverage of the second communication device 204, e.g. because the first user and subscriber 216 leaves the room 214, the communication services that had previously been transferred to the second communication device 204 will be transferred back to the first communication device 202, without interrupting the communication session (in other words within the same running communication session with the third communication device 206), using a similar mechanism as for the transfer of the respective communication service(s) from the first communication device 202 to the second communication device 204. In this case, the first communication device 202 may only provide those communication service(s) (using those communication service parameter(s)) that it initially provided in the communication session before the transfer of communication service(s) had been carried out within the communication session.

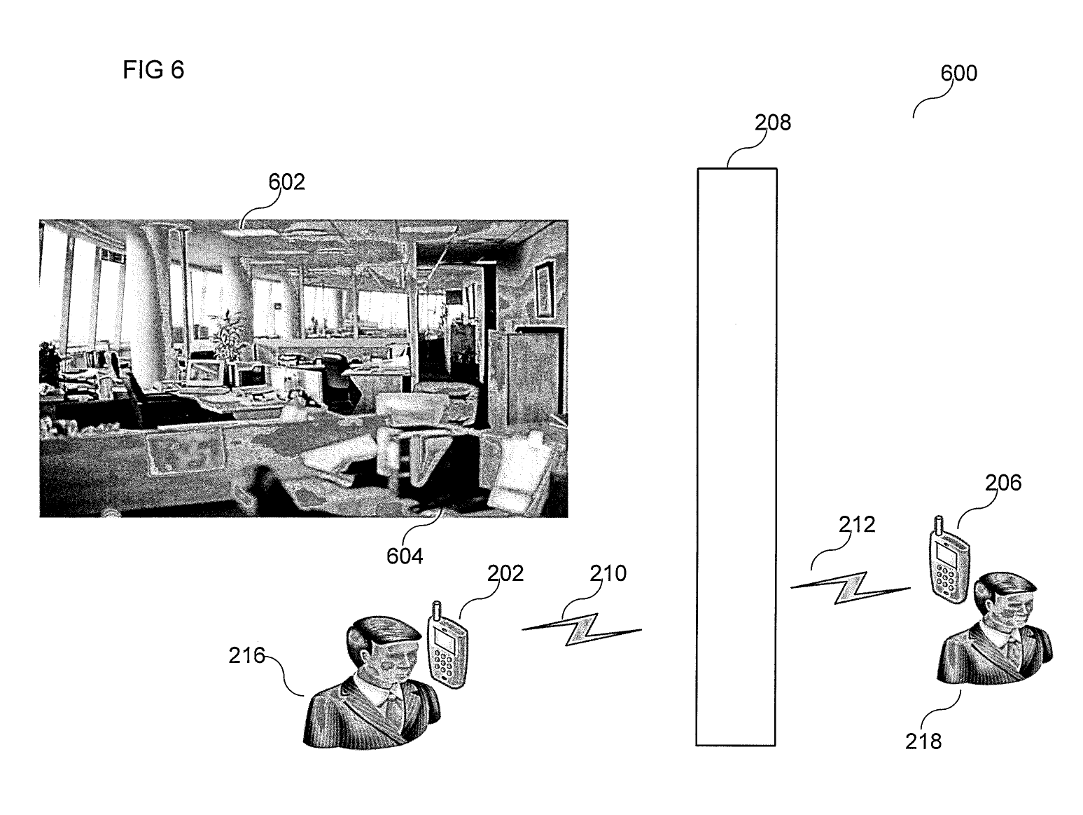

FIG. 6 shows a communication system 600 in accordance with various aspects of the disclosure. The communication system 600 of FIG. 6 is similar to the communication system 200 of FIG. 2; therefore, only the differences will be described in the following in more detail. With respect to the other features, reference is made to the description of the communication system 200 of FIG. 2.

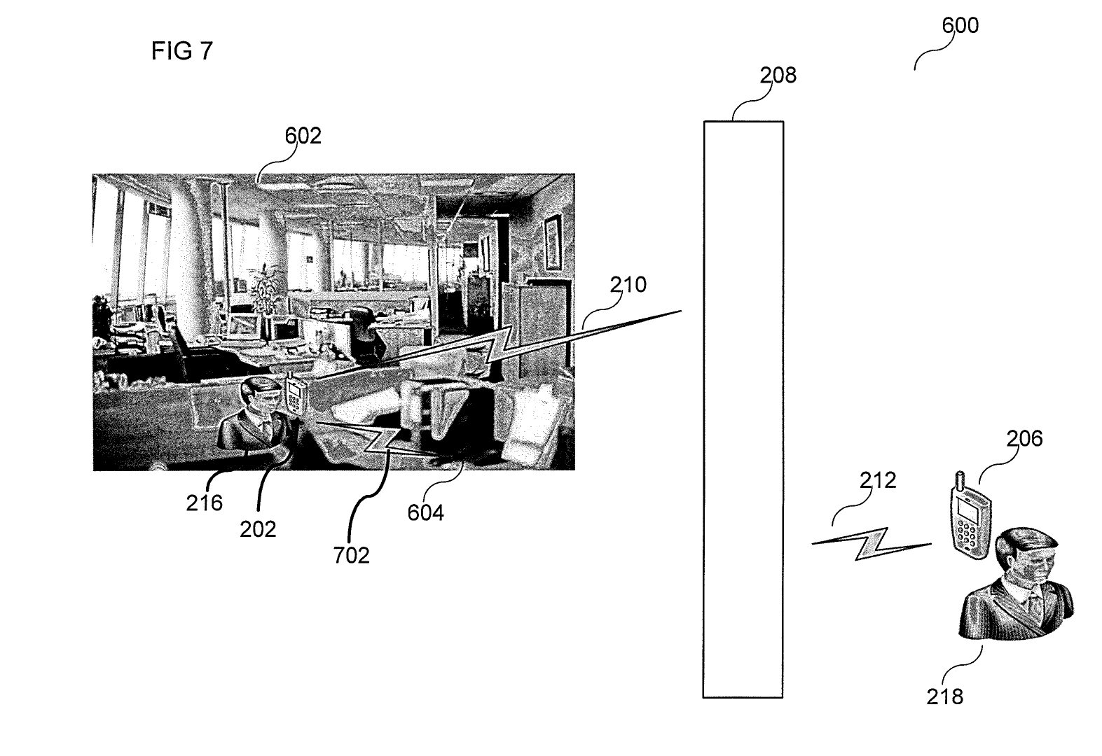

As shown in FIG. 6, a scenario is illustrated in which the user and subscriber 216 is first out of an office 602 and then, as shown in FIG. 7, enters the office 602. As shown in FIG. 6, there is a wireline telephone 604 as an implementation of the second communication device 204 in the office 602. The wireline telephone 604 may have a similar structure as the second communication device 204, but with only a small display 408 and without a TV receiver circuit 410, but e.g. including a wireline telephone processing circuit configured to encode/decode wireline telephone signals (i.e. audio signals) (and optionally video signals). Thus, the wireline telephone 604 may be configured to provide audio communication service and/or video communication service. In various aspects, wireline telephone 604 may be configured to provide audio processing e.g. with a higher encoding/decoding rate (and thus with a higher resolution) as the first communication device 202.

The user and subscriber 216 has established a running communication session with the second user and subscriber 218 via the first communication device 202 and the third communication device 206. It is assumed that, while the communication session is running, the short range transceiver 318 of the first communication device 202 and the short range transceiver 418 of the second communication device 204 are activated so that they are scanning their environment for other short range radio devices and, upon finding one, starting the procedure to establish a short range radio connection 502 between the respective communication devices, e.g. between the first communication device 202 and the second communication device 204. Thus, in case the first communication device 202 enters the scanning region of the second communication device 204, a short range radio connection 502 between the first communication device 202 and the second communication device 204 will automatically be established.

After having established a short range communication connection 702 between the first communication device 202 and the second communication device 204, information about the second communication device's capabilities will be provided from the second communication device 204 to the first communication device 202. The first communication device 202 may, upon receipt of the second communication device's capability information, determine as to whether it may be appropriate to provide one or more communication services provided in the communication session by the first communication device 202 up to that moment by the second communication device 204. In this implementation, it is assumed that the audio capabilities and/or video capabilities of the second communication device 204 provide a better audio quality and/or video quality than the first communication device 202. After having determined this, e.g. using the received second communication device's capability information, the first communication device 202 (e.g. the processor 302 of the first communication device 202) may decide to establish an audio connection and/or a video connection between the first communication device 202 and the second communication device 204 and transfer an audio communication service and/or a video communication service from the first communication device 202 to the second communication device 204 (via the first communication device 202) while keeping the communication session running and while keeping the audio communication service provided by the first communication device 202. As an alternative, e.g. the first communication device 202 may decide to transfer all communication services to the second communication device 204. The second communication device 204 may thus provide the audio communication service and/or the video communication service using other communication service parameters (e.g. other display resolution, other encoding/decoding algorithms or parameters) than the first communication device 202. By way of example, the first communication device 202 may provide the audio communication service in the communication session using ITU G.711 for audio processing and the second communication device 204 may provide the audio communication service in the communication session using AMR-NB or AMR-WB for audio processing.

If the first user and subscriber 216 and thus the first communication device 202 leaves the range of coverage of the second communication device (e.g. the wireline telephone 604), e.g. because the first user and subscriber 216 leaves the office 602, the communication services that had previously been transferred to the wireline telephone 604 will be transferred back to the first communication device 202, without interrupting the communication session (in other words within the same running communication session with the third communication device 206), using a similar mechanism as for the transfer of the respective communication service(s) from the first communication device 202 to the wireline telephone 604. In this case, the first communication device 202 may only provide those communication service(s) (using those communication service parameter(s)) that it initially provided in the communication session before the transfer of communication service(s) had been carried out within the communication session.

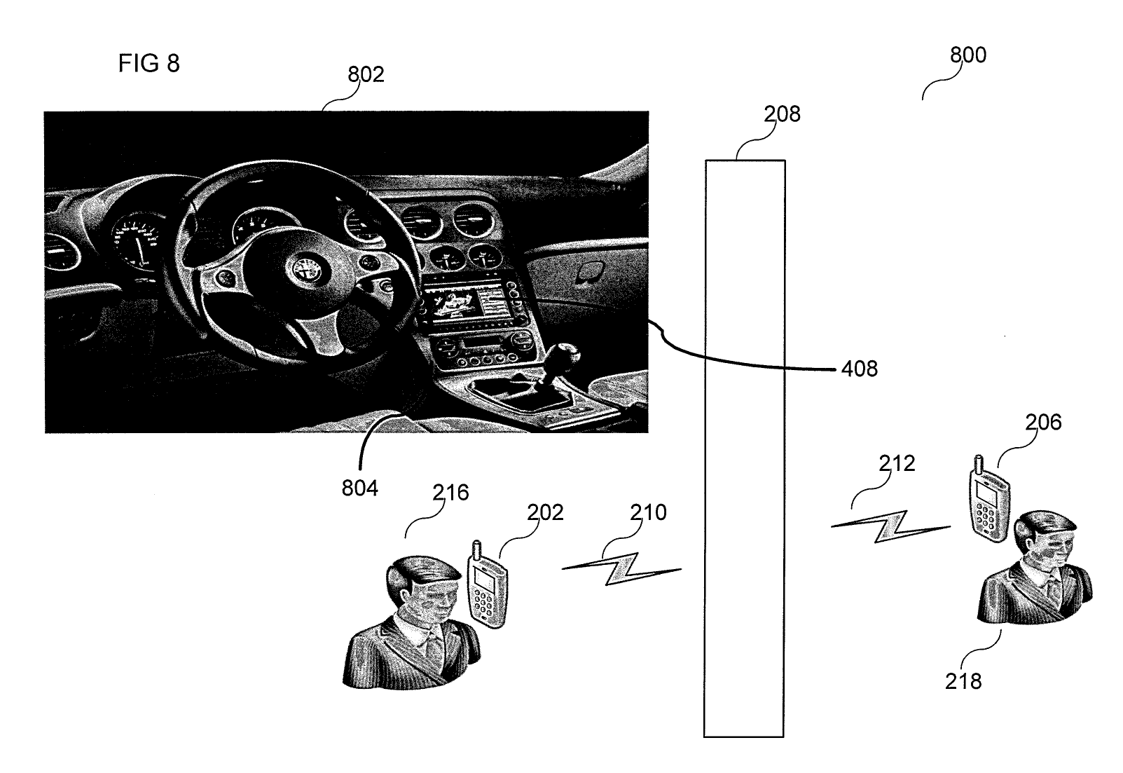

FIG. 8 shows a communication system 800 in accordance with various aspects of the disclosure. The communication system 800 of FIG. 8 is similar to the communication system 200 of FIG. 2; therefore, only the differences will be described in the following in more detail. With respect to the other features, reference is made to the description of the communication system 200 of FIG. 2.

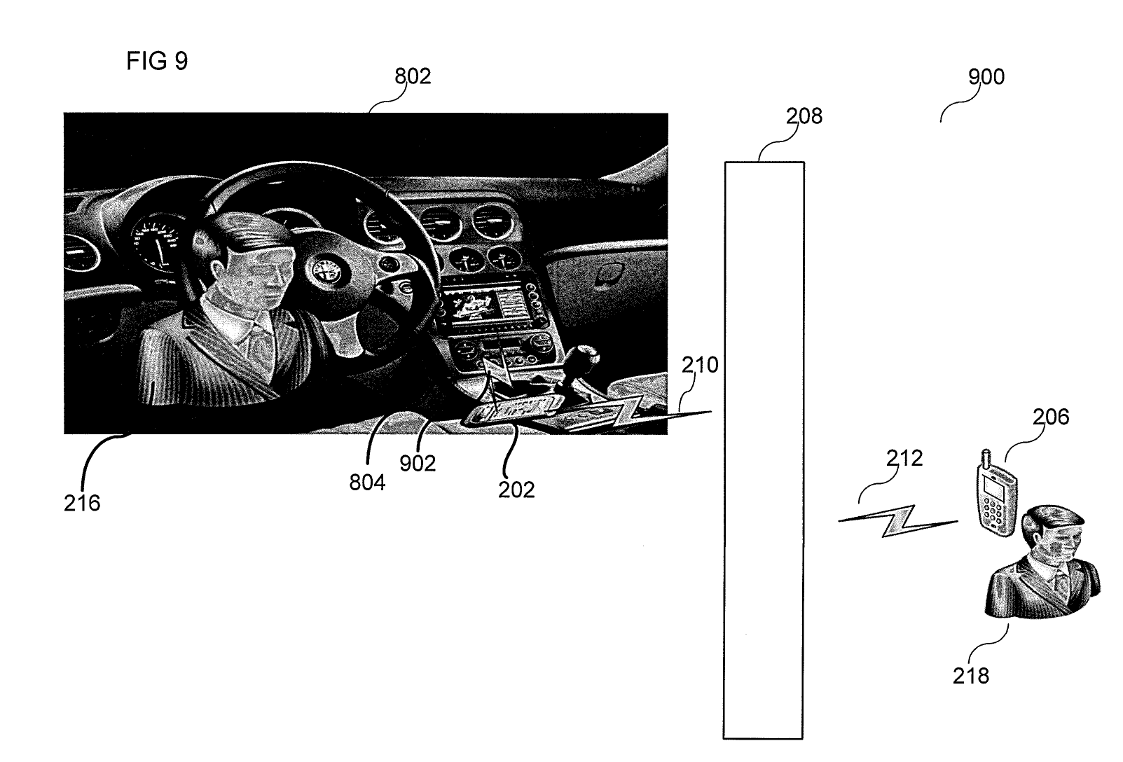

As shown in FIG. 8, a scenario is illustrated in which the user and subscriber 216 is first out of a vehicle, e.g. a car 802, and then, as shown in FIG. 9, enters the car 802. As shown in FIG. 8, there is a telephone 804 integrated in the car 802 as an implementation of the second communication device 204 in the car 802. The telephone 804 may have a similar structure as the second communication device 204, but with only a small display 408 and without a TV receiver circuit 410, but e.g. including an audio processing circuit configured to encode/decode audio signals, but no video signals. Thus, the telephone 804 may be configured to provide audio communication service only. In various aspects, telephone 804 may be configured to provide audio processing e.g. with a higher encoding/decoding rate (and thus with a higher resolution) as the first communication device 202.

The user and subscriber 216 has established a running communication session with the second user and subscriber 218 via the first communication device 202 and the third communication device 206, in this case including an audio communication service as well as a video communication service. It is assumed that, while the communication session is running, the short range transceiver 318 of the first communication device 202 and the short range transceiver 418 of the second communication device 204 are activated so that they are scanning their environment for other short range radio devices and, upon finding one, starting the procedure to establish a short range radio connection 902 between the respective communication devices, e.g. between the first communication device 202 and the second communication device 204. Thus, in case the first communication device 202 enters the scanning region of the second communication device 204, a short range radio connection 902 between the first communication device 202 and the second communication device 204 will automatically be established.

After having established a short range communication connection 902 between the first communication device 202 and the second communication device 204, information about the second communication device's capabilities will be provided from the second communication device 204 to the first communication device 202. The first communication device 202 may, upon receipt of the second communication device's capability information, determine as to whether it may be appropriate to provide one or more communication services provided in the communication session by the first communication device 202 up to that moment by the second communication device 204 (in this scenario it may be appropriate since the driver (the user and subscriber 216) may want to use a hands-free speakerphone installed in the car 802 within the communication session. In this implementation, it is assumed that the audio capabilities of the second communication device 204 (which has no video capabilities) provides a higher audio quality than the first communication device 202. After having determined that the audio communication service within the established communication session should be provided by the second communication device 204, e.g. using the received second communication device's capability information, the first communication device 202 (e.g. the processor 302 of the first communication device 202) may decide to establish an audio connection between the first communication device 202 and the second communication device 204 and transfer an audio communication service (a possibly existing video communication service may be cancelled) from the first communication device 202 to the second communication device 204 (via the first communication device 202) while keeping the communication session running. As an alternative, e.g. the first communication device 202 may decide to transfer all communication services to the second communication device 204. The second communication device 204 may thus provide the audio communication service using other communication service parameters (e.g. other encoding/decoding algorithms or parameters) than the first communication device 202. By way of example, the first communication device 202 may provide the audio communication service in the communication session using ITU G.711 for audio processing and the second communication device 204 may provide the audio communication service in the communication session using ITU G.711 for audio processing, however, with an increased bitrate.

In various aspects of the disclosure, the determination as to whether one or more communication services should be provided by the second communication device 204 may be provided using pre-defined (e.g. user-defined) rules (e.g. in the form of a rule file), which may e.g. be stored in the respective communication device (e.g. the first communication device 202 and/or the second communication device 204) or in a central entity, in which case the rules (e.g. the rule file) may be transmitted to the deciding communication device, e.g. the first communication device 202.

If the first user and subscriber 216 and thus the first communication device 202 leaves the range of coverage of the second communication device 204 (e.g. of the car telephone 804), e.g. because the first user and subscriber 216 leaves the car 802, the communication services that had previously been transferred to the car telephone 804 will be transferred back to the first communication device 202, without interrupting the communication session (in other words within the same running communication session with the third communication device 206), using a similar mechanism as for the transfer of the respective communication service(s) from the first communication device 202 to the car telephone 804. In this case, the first communication device 202 may only provide those communication service(s) (using those communication service parameter(s)) that it initially provided in the communication session before the transfer of communication service(s) had been carried out within the communication session.

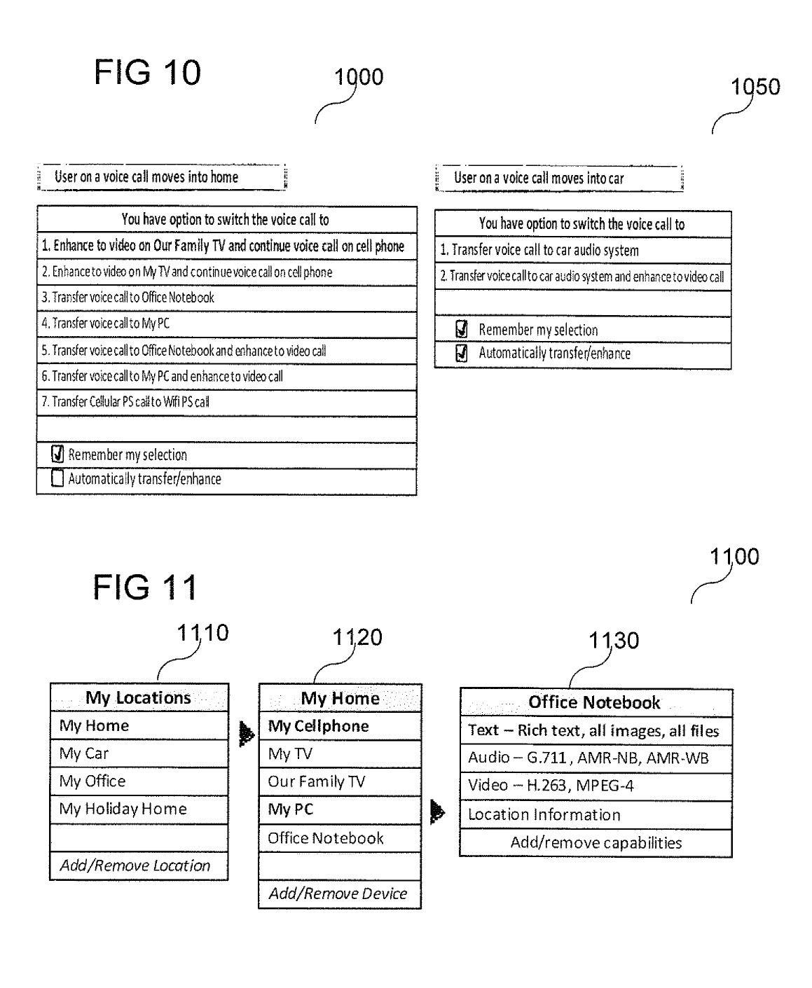

FIG. 10 shows a first rule file 1000 and a second rule file 1050 in accordance with various aspects of the disclosure.

The first rule file 1000 and the second rule file 1050 may be stored in the first memory 304 of the first communication device 202. As shown in FIG. 10, the first rule file 1000 may include freely selectable rules as to how the first communication device 202 should handle communication service transfers in a running communication session when the first communication device 202 enters the home environment and at that stage only has established an audio communication service.

By way of example, in accordance with the first rule file 1000, the user of the first communication device 202 may select to

1. Establish (enhance) to video communication service on a family TV (i.e. the second communication device 204) and to continue the audio communication service provided by the first communication device 202.

2. Establish a (enhance to) video communication service on a user's private TV (i.e. the second communication device 204) and to continue the audio communication service provided by the first communication device 202.

3. Transfer the audio communication service to be provided by an office notebook which may be present in the home environment.

4. Transfer the audio communication service to be provided by a user's personal computer which may be present in the home environment.

5. Transfer the audio communication service to be provided by an office notebook which may be present in the home environment, and establish a (enhance to) video communication service on the office notebook.

6. Transfer the audio communication service to be provided by a user's personal computer which may be present in the home environment, and establish a (enhance to) video communication service on the user's personal computer.

7. Transfer a text communication service to a communication device using a WiFi communication connection.

As also shown in FIG. 10, the second rule file 1050 may include freely selectable rules as to how the first communication device 202 should handle communication service transfers in a running communication session when the first communication device 202 enters a car and at that stage only has established an audio communication service.

By way of example, in accordance with the second rule file 1050, the user of the first communication device 202 may select to:

1. Transfer the audio communication service from the first communication device 202 to the car audio system, i.e. the second communication device 204 in the car 802.

2. Transfer the audio communication service from the first communication device 202 to the car audio system, i.e. the second communication device 204 in the car 802, and enhance the quality of the audio communication service.

FIG. 11 shows an example user interface 1100 to set up rules in the rule files 1000 or 1050 and to set capabilities of a respective communication device. The user interface 1100 shows various select menus 1110, 1120, 1130 to input respectively offered options as shown in the respective select menu 1110, 1120, 1130.

The concrete implementation of the discovery of the second communication device 204 may depend on the short range communication technology and may be selected accordingly. Furthermore, the capability discovery, in other words, the mechanism provided to exchange the information about the capabilities of the respective communication device may be provided using a proprietary protocol or a standardized communication protocol, e.g. a standardized control communication protocol, e.g. the Session Initiation Protocol (SIP). Various possible implementations of message flows between the communication devices will be described in more detail below in the context of SIP messages and mechanisms.

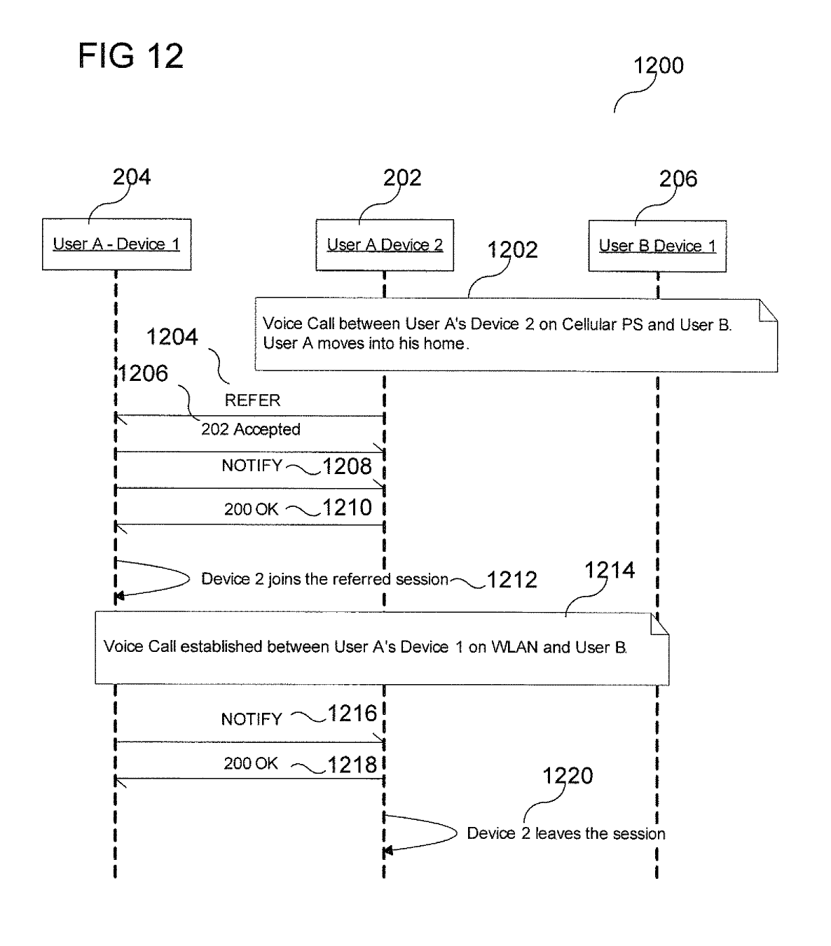

FIG. 12 shows a message flow diagram 1200 in accordance with various aspects of the disclosure illustrating a method for providing a communication session.

In this scenario, it is assumed that the first communication device 202 of the first user and subscriber 216 has an established communication session including only an audio communication service via a packet-switched (PS) communication connection via a mobile radio wide area cell technology such as e.g. a 3GPP technology such as e.g. LTE or UMTS as described above, with the third communication device 206 of the second user and subscriber 218. Furthermore, it is assumed that the first user and subscriber 216 and with him the first communication device 202 moves into his home (as shown in FIG. 2 and FIG. 5, for example). This scenario is symbolized in FIG. 12 by means of block 1202.

In various aspects of the disclosure, upon entry of the home the first communication device 202 and the second communication device 204 carry out a communication device discovery method. The communication devices proximity and locations may be (statically) pre-configured in the first communication device 202 and/or in the second communication device 204, or they may be dynamically discovered on the network by means of an interaction of the first communication device 202 and the second communication device 204. The dynamic communication device discovery methods may be proprietary methods or standard methods of e.g. Universal Plug and Play (UPnP) discovery methods, or SIP NOTIFY mechanism for registration-event package, etc. The locations may be an office, a car, a home, etc. New locations and new communication devices could be added to a trusted list (which may be stored in a memory, e.g. the first memory and/or the second memory of the first communication device 202 or the second communication device 204). Existing locations and devices could be removed from the trusted list.

As soon as a short range communication connection has been established between the first communication device 202 and the second communication device 204 (i.e. after the communication devices have discovered each other), the first communication device 202 may generate and send (e.g. via the second (short range) transceiver 318) a SIP REFER message 1204 to the second communication device 204, which in turn may receive the SIP REFER message 1204 via his second (short range) transceiver 418.

The SIP REFER message 1204 may have the following structure:

REFER sip:UserADevice1@Intel.com SIP/2.0

To: sip:UserADevice1@Intel.com

From: <sip:UserADevice2@Intel.com>;tag=193402342

Call-ID: 898234234@UserADevice2.Intel.com

CSeq: 93809823 REFER

Max-Forwards: 70

Refer-To: sip:UserBDevice1@Intel.com

Contact: sip:UserA@Device2.Intel.com

Content-Length: 0

The SIP REFER message 1204 may include a session identifier (session ID) (uniquely) identifying the already established communication session between the first communication device 202 and the second communication device 204.

After having received the SIP REFER message 1204, the second communication device 204 may acknowledge receipt of the SIP REFER message 1204 to the first communication device 202 by generating and sending a SIP 202 Accepted message 1206 to the first communication device 202.

The SIP 202 Accepted message 1206 may have the following structure:

SIP/2.0 202 Accepted

To: <sip:UserADevice2@Intel.com>;tag=4992881234

From: <sip:UserADevice1@Intel.com>;tag=193402342

Call-ID: 898234234@UserADevice2.Intel.com

CSeq: 93809823 REFER

Contact: sip:UserA@Device1.Intel.com

Content-Length: 0

Furthermore, the second communication device 204 may determine its own device capabilities e.g. with respect to the optionally in the SIP REFER message 1204 indicated communication service(s) provided and/or desired in the running communication session. The device capabilities of the second communication device 204 may be transmitted to the first communication device 202 by various mechanisms, e.g. by generating and sending a SIP OPTIONS message or by means of generating and sending a first SIP NOTIFY message 1208 to the first communication device 202.

In general, the communication devices' capability, proximity and locations of the devices may be identified by means of: SIP OPTIONS exchange method or combination of SIP PUBLISH, SUBSCRIBE & NOTIFY. The communication device capabilities could respectively be pre-configured as well. SIP OPTIONS message may include audio capabilities (e.g. ITU G.711, AMR-NB, AMR-WB, AMBE, etc), video capabilities (e.g. ITU H.261, ITU H.263, ITU H.264, MPEG (e.g. MPEG 2, MPEG 4, MPEG 7 . . . ), SQCIF, QCIF, CIF, VGA, 4CIF, etc.) and chat capabilities (e.g. text types, image types, file types, etc.). Alternate methods for capability exchange may be using a combination of SIP PUBLISH, SUBSCRIBE & NOTIFY and may involve PUBLISHing mechanism of SIP of the device capabilities, SUBSCRIBEing mechanism of SIP for device capabilities and getting NOTIFYs according to the respective SIP mechanism for getting device capabilities. The device capabilities may be included in .xml format as “Content-type: application/xml”. The device capabilities of the communication devices may persistently be cached for being efficient—e.g. for a non-mobile communication device, if a communication device's capabilities are previously discovered, subsequent capability discovery of a communication device shall only be based on user's request. Furthermore, the second communication device may determine the communication device capabilities also from the third communication device. Thereby, the second communication device may e.g. determine as to whether the third communication device would at all be able to establish an additional video communication service connection within the communication session, which has initially begun only with a voice call communication service with the first communication device. This communication device capabilities may be determined in the same way as the second communication device determines the communication device capabilities of the first communication device.

In the following, an example of a device capability file or structure in .xml format is shown:

<?xml version=″1.0″ encoding=″UTF-8″?>
<device-capabilities xmlns=″urn:intel:xml:multicomm:device-caps″>
<device-caps uri=″sip:UserAOfficeNotebook@Intel.com″>

<device-id>AB1973CD08EF30AB</device-id>

<communication-addresses>

<comm-addr>10.224.161.49</comm-addr>
<comm-addr>2001:0db8:85a3:0000:0000:8a2e:0370:7334</comm-addr>
<comm-addr> sip:UserAOfficeNotebook@Intel.com</comm-addr>

</communication-addresses>
<display-name xml:lang=″en″>User A Office Notebook</display-name>

<audio-codecs>

<audio-codec>G.711</audio-codec>
<audio-codec>AMR-NB</audio-codec>
<audio-codec>AMR-WB</audio-codec>

</audio-codecs>
<video-codecs>

<video-codec>H.263</video-codec>
<video-codec>H.264</video-codec>
<video-codec>MPEG-2</video-codec>

</video-codecs>
<text-types>

<text-type xml:lang=”en”>* </text-type>

</text-types>
<device-location>

<location-type>My Home</location-type>
<coordinates>37:46:30N 122:25:10W</coordinates>

</device-location>

</device-caps>
</device-capabilities>

The first SIP NOTIFY message 1208 may have the following structure:

NOTIFY sip:UserADevice2@Intel.com SIP/2.0

To: <sip:UserADevice2@Intel.com>;tag=193402342

From: <sip:UserADevice1@Intel.com>;tag=4992881234

Call-ID: 898234234@UserADevice2.Intel.com

CSeq: 1993402 NOTIFY

Max-Forwards: 70

Event: refer

Subscription-State: active;expires=1000

Contact: sip:UserA@Device1.Intel.com

Content-Type: message/sipfrag;version=2.0

Content-Length: 20

A SIP/2.0 100 Trying message may be provided in some implementations to to indicate the message transfer status to the originating device.

After having received the SIP NOTIFY message 1208, the first communication device 202 may acknowledge receipt of the SIP NOTIFY message 1208 to the second communication device 204 by generating and sending a SIP 200 OK message 1210 to the second communication device 204. Furthermore, the first communication device 202 may store the received device capabilities of the second communication device 204.

The SIP 200 OK message 1210 may have the following structure:

SIP/2.0 200 OK

To: <sip:UserADevice2@Intel.com>;tag=193402342

From: <sip:UserADevice1@Intel.com>;tag=4992881234

Call-ID: 898234234@UserADevice2.Intel.com

CSeq: 1993402 NOTIFY

Contact: sip:UserA@Device1.Intel.com

Content-Length: 0

Then, the second communication device 204 may join the communication session referred to in the SIP REFER message 1204, e.g. using the session ID of the communication session which may have been transmitted to the first communication device 202 in the SIP REFER message 1204 (symbolized in FIG. 12 with reference number 1212).

In 1214, the second communication device 204 may establish a voice call communication service connection within the communication session with the third communication device 206, e.g. via a WLAN connection (and thus e.g. using an encoding technology providing a higher quality and requiring a higher bandwidth), which would then join into the mobile radio wide area cell communication connection provided between the first communication device 202 and the third communication device 206 at the beginning of the communication session.

After the voice call communication service connection via WLAN has been established between the second communication device 204 and the third communication device 206, the second communication device 204 informs the first communication device 202 about the newly established voice call communication service connection, e.g. by generating a corresponding second SIP NOTIFY message 1216 and transmitting the same to the first communication device 202.

The second SIP NOTIFY message 1216 may have the following structure:

NOTIFY sip:UserADevice2@Intel.com SIP/2.0

To: <sip:UserADevice2@Intel.com>;tag=193402342

From: <sip:UserADevice1@Intel.com>;tag=4992881234

Call-ID: 898234234@UserADevice2.Intel.com

CSeq: 1993402 NOTIFY

Max-Forwards: 70

Event: refer

Subscription-State: active;expires=1000

Contact: sip:UserA@Device1.Intel.com

Content-Type: message/sipfrag;version=2.0

Content-Length: 20

A SIP/2.0 100 Trying message may be provided in some implementations to to indicate the message transfer status to the originating device.

Upon receipt of the second SIP NOTIFY message 1216 (e.g. via the second transceiver 318), the first communication device 202 may generate another SIP 200 OK message and may transmit the same to the second communication device 204.

The other SIP 200 OK message 1210 may have the following structure:

SIP/2.0 200 OK

To: <sip:UserADevice2@Intel.com>;tag=193402342

From: <sip:UserADevice1@Intel.com>;tag=4992881234

Call-ID: 898234234@UserADevice2.Intel.com

CSeq: 1993402 NOTIFY

Contact: sip:UserA@Device1.Intel.com

Content-Length: 0

Then, the first communication device 202 may leave the communication session in 1220. The first communication device 202 may inform the second communication device 204 about it leaving the communication session by generating a third SIP NOTIFY message (not shown in the Figure) and by transmitting the same to the second communication device 204.

The third SIP NOTIFY message may have the following structure:

NOTIFY sip:UserADevice2@Intel.com SIP/2.0

To: <sip:UserADevice2@Intel.com>;tag=193402342

From: <sip:UserADevice1@Intel.com>;tag=4992881234

Call-ID: 898234234@UserADevice2.Intel.com

CSeq: 1993403 NOTIFY

Max-Forwards: 70

Event: refer

Subscription-State: terminated;reason=noresource

Contact: sip:UserA@Device1.Intel.com

Content-Type: message/sipfrag;version=2.0

Content-Length: 16

Upon receipt of the third SIP NOTIFY message (e.g. via the second transceiver 318), the second communication device 204 may generate a third SIP 200 OK message (not shown) and may transmit the same to the first communication device 202.

The third SIP 200 OK message may have the following structure:

SIP/2.0 200 OK

To: <sip:UserADevice2@Intel.com>;tag=193402342

From: <sip:UserADevice1@Intel.com>;tag=4992881234

Call-ID: 898234234@UserADevice2.Intel.com

CSeq: 1993403 NOTIFY

Contact: sip:UserA@Device1.Intel.com

Content-Length: 0

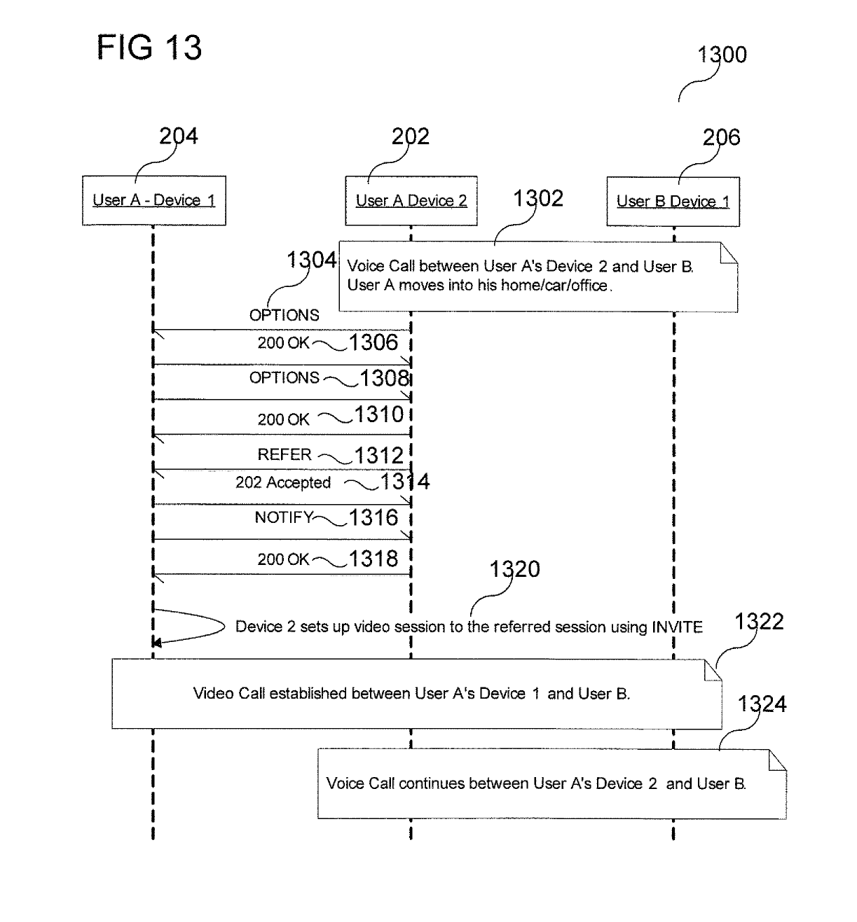

FIG. 13 shows a message flow diagram 1300 in accordance with various aspects of the disclosure illustrating a method for providing a communication session.

In this scenario, it is assumed that the first communication device 202 of the first user and subscriber 216 has an established communication session including only an audio communication service via a packet-switched (PS) communication connection via a mobile radio wide area cell technology such as e.g. a 3GPP technology such as e.g. LTE or UMTS as described above, with the third communication device 206 of the second user and subscriber 218. Furthermore, it is assumed that the first user and subscriber 216 and with him the first communication device 202 moves into his home, his car or his office (as shown in FIG. 2 and FIG. 5, for example). This scenario is symbolized in FIG. 13 by means of block 1302.

As shown in FIG. 13, the first communication device 202 may generate a first SIP OPTIONS message 1304, which includes the communication device capabilities e.g. with respect to the communication service (e.g. media type, encoding/decoding technology, quality of service parameters, etc.) supported by the first communication device 202, and transmits the same to the second communication device 204.

The first SIP OPTIONS message 1304 may have the following structure:

OPTIONS sip:UserADevice2@Intel.com SIP/2.0

Max-Forwards: 70

To: sip:UserADecive2@Intel.com

From: <sip:UserADevice1@Intel.com>;tag=1928301774

Call-ID: a84b4c76e66710

CSeq: 63104 OPTIONS

Contact: sip:UserA@Device1.Intel.com

Accept: application/xml

Content-Length: 0

After having received the first SIP OPTIONS message 1304, the second communication device 204 may acknowledge receipt of the first SIP OPTIONS message 1304 to the first communication device 202 by generating and sending a first SIP 200 OK message 1306 to the first communication device 202. Furthermore, the second communication device 204 may store the received device capabilities of the first communication device 202.

The first SIP 200 OK message 1306 may have the following structure:

SIP/2.0 200 OK

To: <sip:UserADevice1@Intel.com>;tag=93810874

From: <sip:UserADevice2@Intel.com>;tag=1928301774

Call-ID: a84b4c76e66710

CSeq: 63104 OPTIONS

Contact: sip:UserA@Device2.Intel.com

Allow: INVITE, ACK, CANCEL, OPTIONS, BYE

Accept: application/xml

Accept-Language: en

Content-Type: application/xml

Content-Length: 804

Furthermore, the second communication device 204 may generate a second SIP OPTIONS message 1308, which may include the communication device capabilities e.g. with respect to the communication service (e.g. media type, encoding/decoding technology, quality of service parameters, etc.) supported by the second communication device 204, and may transmit the same to the first communication device 202. Since the SIP messages mentioned in the following may have a similar structure as the SIP messages described above, a repetitive description of their structures will be omitted.

The second SIP OPTIONS message 1308 may include the communication device capabilities of the second communication device, e.g. in an .xml format. Such a file or structure may look as follows:

<?xml version=“1.0” encoding=“UTF-8”?>

<device-capabilities xmlns=“urn:intel:xml:multicomm:device-caps”>
<device-caps uri=“sip:UserA@Device1.Intel.com”>

<device-id>AB1973CD08EF30AB</device-id>
<communication-addresses>

<comm-addr>10.224.161.49</comm-addr>
<comm-

addr>2001:0db8:85a3:0000:0000:8a2e:0370:7334</comm-addr>

<comm-addr> sip:UserA@Device1.Intel.com</comm-

addr>

</communication-addresses>

<display-name xml:lang=“en”>My TV</display-name>
<video-codecs>

<video-codec>H.263</video-codec>
<video-codec>H.264</video-codec>
<video-codec>MPEG-2</video-codec>

</video-codecs>
<device-location>

<location-type>My Home</location-type>
<coordinates>37:46:30N 122:25:10W</coordinates>

</device-location>

</device-caps>
</device-capabilities>

After having received the second SIP OPTIONS message 1308, the first communication device 202 may acknowledge receipt of the second SIP OPTIONS message 1308 to the second communication device 204 by generating and sending a second SIP 200 OK message 1310 to the second communication device 204. Furthermore, the first communication device 202 may store the received device capabilities of the second communication device 204.

The first communication device 202 may generate and send (e.g. via the second (short range) transceiver 318) a SIP REFER message 1312 to the second communication device 204, which in turn may receive the SIP REFER message 1312 via his second (short range) transceiver 418.

The SIP REFER message 1312 may include a session identifier (session ID) (uniquely) identifying the already established communication session between the first communication device 202 and the second communication device 204.

After having received the SIP REFER message 1312, the second communication device 204 may acknowledge receipt of the SIP REFER message 1312 to the first communication device 202 by generating and sending a SIP 202 Accepted message 1314 to the first communication device 202.

Furthermore, the second communication device 204 may inform the first communication device 202 that he is going to set up a corresponding communication service connection within the communication session referred to in the SIP REFER message 1312 by generating a SIP NOTIFY message 1316 and transmitting the same to the first communication device 202.

After having received the SIP NOTIFY message 1316, the first communication device 202 may acknowledge receipt of the SIP NOTIFY message 1316 to the second communication device 204 by generating and sending a third SIP 200 OK message 1318 to the second communication device 204.

Then, the second communication device 204 may set up a video communication connection with the third communication device 206 within the communication session referred to in the SIP REFER message 1312, e.g. using the session ID of the communication session which may have been transmitted to the first communication device 202 in the SIP REFER message 1312 and e.g. using a SIP INVITE message transmitted to the third communication device 206 (symbolized in FIG. 13 with reference number 1320), thereby providing a video call communication service within the running communication session (symbolized in FIG. 13 with reference number 1322).

It is to be noted that in this implementation, the voice call communication service to the third communication device 206 initially provided by the first communication device 202 continues between the first communication device 202 and the third communication device 206 (symbolized in FIG. 13 by means of reference number 1324). Thus, illustratively, in various implementations, different communication services (in this example voice call communication service and video communication service) may be provided by different communication devices (e.g. the first communication device 202 and the second communication device 204) within the same established and running communication session with the third communication device 206.

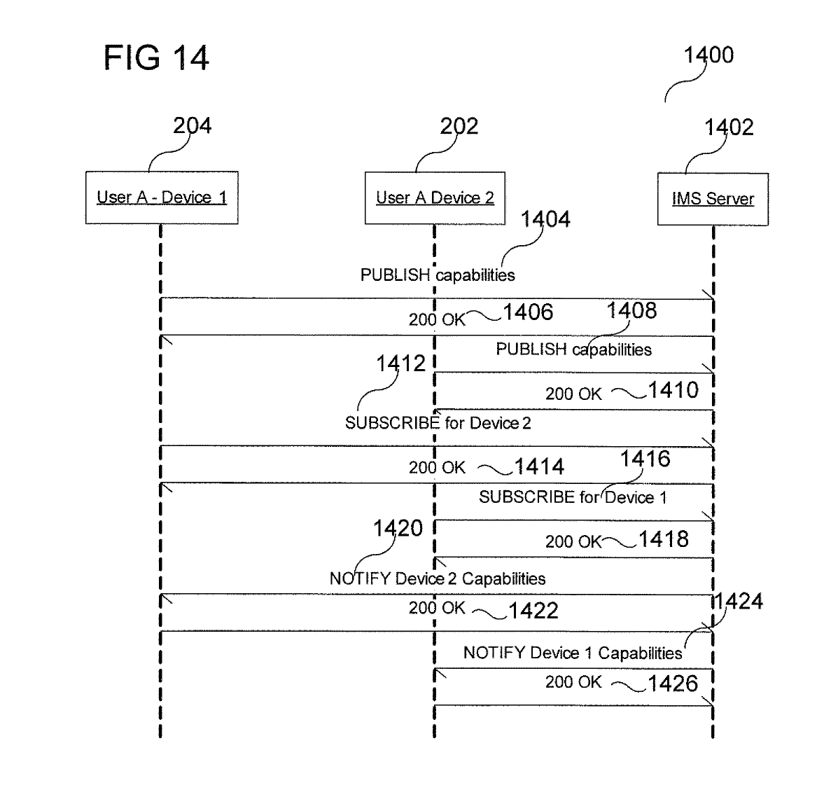

FIG. 14 shows a message flow diagram 1400 in accordance with various aspects of the disclosure illustrating an exchange of communication device capabilities between communication devices, e.g. between the first communication device 202 and the second communication device 204 using a provided Internet Protocol Multimedia Subsystem (IMS) server 1402.

As shown in FIG. 14, the second communication device 204 informs the IMS server 1402 about its own communication device capabilities by generating a first SIP PUBLISH capabilities message 1404 and by transmitting the same to the IMS server 1402.

After having received the first SIP PUBLISH capabilities message 1404, the IMS server 1402 may acknowledge receipt of the first SIP PUBLISH capabilities message 1404 to the second communication device 204 by generating and sending a first SIP 200 OK message 1406 to the second communication device 204. Furthermore, the IMS server 1402 may store the received device capabilities of the second communication device 204.

Furthermore, the first communication device 202 may also inform the IMS server 1402 about its own communication device capabilities by generating a second SIP PUBLISH capabilities message 1408 and by transmitting the same to the IMS server 1402.

After having received the second SIP PUBLISH capabilities message 1408, the IMS server 1402 may acknowledge receipt of the second SIP PUBLISH capabilities message 1408 to the first communication device 202 by generating and sending a second SIP 200 OK message 1410 to the first communication device 202. Furthermore, the IMS server 1402 may store the received device capabilities of the first communication device 202.

In order to receive the communication device capabilities of the first communication device 202, the second communication device 204 may generate a first SIP SUBSCRIBE message 1412 for the communication device capabilities of the first communication device 202 and may transmit the same to the IMS server 1402.

After having received the first SIP SUBSCRIBE message 1412, the IMS server 1402 may acknowledge receipt of the first SIP SUBSCRIBE message 1412 to the second communication device 204 by generating and sending a third SIP 200 OK message 1414 to the second communication device 204. Furthermore, the IMS server 1402 may register the second communication device 204 to be notified about the communication device capabilities of the first communication device 202.

Furthermore, in order to receive the communication device capabilities of the second communication device 204, the first communication device 202 may generate a second SIP SUBSCRIBE message 1416 for the communication device capabilities of the second communication device 204 and may transmit the same to the IMS server 1402.

After having received the second SIP SUBSCRIBE message 1416, the IMS server 1402 may acknowledge receipt of the second SIP SUBSCRIBE message 1416 to the first communication device 202 by generating and sending a fourth SIP 200 OK message 1418 to the first communication device 202. Furthermore, the IMS server 1402 may register the first communication device 202 to be notified about the communication device capabilities of the second communication device 204.

Moreover, as also shown in FIG. 14, the IMS server 1402 may inform the second communication device 204 about the communication device capabilities of the first communication device 202 by generating a first SIP NOTIFY message 1420 which may include the communication device capabilities of the first communication device 202 and may transmit the same to the second communication device 204.

After having received the first SIP NOTIFY message 1420, the second communication device 204 may acknowledge receipt of the first SIP NOTIFY message 1420 to the IMS server 1402 by generating and sending a fifth SIP 200 OK message 1422 to the IMS server 1402. Furthermore, the second communication device 204 may store the received device capabilities of the first communication device 202.

The IMS server 1402 may also inform the first communication device 202 about the communication device capabilities of the second communication device 204 by generating a second SIP NOTIFY message 1424 which may include the communication device capabilities of the second communication device 204 and may transmit the same to the first communication device 202.

After having received the second SIP NOTIFY message 1424, the first communication device 202 may acknowledge receipt of the second SIP NOTIFY message 1424 to the IMS server 1402 by generating and sending a sixth SIP 200 OK message 1426 to the IMS server 1402. Furthermore, the first communication device 202 may store the received device capabilities of the second communication device 204.

Thus, the communication devices 202, 204 have knowledge about the communication device capabilities of the respective other communication device 202, 204, which may be owned by the same user (e.g. may share a common (U)SIM identifier).

In general, it is to be noted that the communication service transfer across multiple communication devices may be realized using SIP REFER and SIP INVITE methods. During communication service transfer: ITU G.711 voice call communication service may be changed to AMR-NB voice call communication service or AMR-WB voice call communication service (normal voice call communication service to HD voice call communication service); ITU H.263 video call communication service may be changed to ITU H.264 video call communication service or MPEG video call communication service (normal video call communication service to HD video call communication service), plain text session communication service to rich text session communication service to file transfer session communication service to image share session communication service; or vice versa.

The communication services enrichment and shrink may be based on SIP REFER and SIP RE-INVITE methods. During communication service enrichment: —text session communication service to voice call communication service to video call communication service or shrink video call communication service to voice call communication service to text session communication service may be provided.

The SIP communication may be either peer-to-peer or through one or more SIP servers.

Normal video call communication service may optionally be enhanced to HD video call communication service or vice-versa, voice call communication service may be switched between ITU G.711 communication service, AMR-NB communication service or AMR-WB communication service, and so on.

One effect of various aspects of the disclosure may be the seamless data offloading. Data on expensive and bandwidth constrained mobile radio wide area cellular network may be transferred to low cost and high bandwidth WLAN kind of communication networks whenever possible.

There may be three architectural alternatives:

1. Device Discovery: UPnP communication device discovery or SIP based REGISTER-NOTIFY for registration-event package or preconfigured or pre-configured or a combination of these.

2. Capability discovery: UPnP capability discovery or SIP OPTIONS or SIP PUBLISH, SUBSCRIBE & NOTIFY or pre-configured or a combination of these.

3. Session Transfer & Enrich: Either peer-to-peer or through SIP server.

Original Equipment Manufacturer (OEM) may directly leverage or extend the software capabilities to offer “Smart Service Transfer and Enrich” to Service Provider customers. This may not only be a value add, but also inherently offers enhanced user experience to transfer a data call from cellular packet switch (PS) to Wifi PS call. OEM delivered PS applications may also be enhanced for transfer and enrichment functionalities with improved End-User experience.

Service Providers may achieve economic benefits by offering the new service of “Smart Service Transfer and Enrichment” as described in various aspects in the disclosure to end users. Also service providers may offer offload of data from a wide area cellular network to Wifi network with only little effort.

The end users experience may be enhanced and enriched by seamless transfer and enrichment of communication services across their different devices at different locations. They may also experience lesser cost whenever a communication service is transferred to Wifi, better battery life when transferred to Wifi and better quality of audio/video communication when communication service can be transferred to a communication device with higher capabilities.

Various aspects of the disclosure seamlessly transfer a communication service (Voice Call communication service, Video Call communication service, Chat communication service, etc.) across multiple communication devices of a user and provide options to enrich (convert voice call communication service to video call communication service) or shrink (video call communication service to voice call communication service to chat communication service) based on users' preference, capability of communication devices, proximity and location. Also, the quality of the transferred or enhanced voice communication service or video call communication services may be modified dynamically based on capability of the communication devices (Normal audio/video call communication service to a HD audio/video call communication service).

In various aspects of the disclosure, a method for providing a communication session may be provided. The method may include establishing, during an established communication session between a first communication device and another communication device, a communication connection with a second communication device; determining, as to whether one or more communication services provided in the communication session by the first communication device should be provided by the second communication device; and in case at least one of the communication services provided in the communication session should be provided by the second communication device, establishing a communication session connection for the at least one communication service of the communication session, and providing the at least one communication service by the second communication device within the established communication session.

The method may further include determining device capabilities of the second communication device with respect to at least one communication service. Furthermore, the at least one communication service may be provided using one or more communication service parameters depending on the determined device capabilities of the second communication device. The method may further include discovering, during an established communication session between a first communication device and another communication device, a second communication device. The method may further include determining as to whether the second communication device is a trusted communication device, when a communication connection with the second communication device is possible; and in case the second communication device is a trusted communication device, establishing the communication connection with the second communication device. The method may further include in case the second communication device is not a trusted communication device, the communication connection with the second communication device is not established. The determining as to whether the second communication device is a trusted communication device may be carried out using a stored trusted device list. Furthermore, the determining of device capabilities of the other communication device may include reading the device capabilities from a stored device capability file. The determining of device capabilities of the second communication device may include receiving a device capability message from the second communication device, and determining the device capabilities from the device capability message. Moreover, the device capability message may include a Session Initiation Protocol message. The device capability message may include a Session Initiation Protocol OPTIONS message. Furthermore, the device capability message may include at least one of a Session Initiation Protocol PUBLISH message, a Session Initiation Protocol SUBSCRIBE message, and a Session Initiation Protocol NOTIFY message. The device capabilities with respect to a communication service may include device capabilities with respect to the processing or outputting media data in accordance with a communication service. The device capabilities with respect to a communication service may include device capabilities with respect to at least one of a group consisting of: text data encoding capabilities; text data decoding capabilities; text data outputting capabilities; audio encoding capabilities; audio decoding capabilities; audio outputting capabilities; video encoding capabilities; video decoding capabilities; and video outputting capabilities. The providing the at least one communication service by the second communication device may include providing additional media types or less media types as provided in the initially established communication session. The establishing a communication connection with the second communication device may include establishing a Local Area Network communication connection with the second communication device. The discovering the second communication device may be carried out using an adhoc communication protocol discovering process. The adhoc communication protocol discovering process may be carried out in accordance with a Bluetooth standard or WiFi (IEEE 802.11) standard. The discovering process may be carried out in accordance with a Wireless Local Area Network standard. The providing the at least one communication service by the second communication device within the established communication session may include providing the at least one communication service using one or more communication service parameters dependent on the device capabilities of the second communication device with respect to the at least one communication service. The communication service parameters may include at least one communication service parameter of the group consisting of: data transmission rate; data encoding rate; data decoding rate; audio data output resolution; and video data output resolution. The establishing the Local Area Network communication connection with the second communication device may include establishing a Wireless Local Area Network communication connection with the second communication device. The establishing the communication connection with the second communication device may include establishing a Personal Area Network communication connection with the second communication device. The establishing the communication connection with the second communication device may include establishing an adhoc communication network communication connection with the second communication device. The establishing the adhoc communication network communication connection with the second communication device may include establishing a short range communication network communication connection with the second communication device. A user may be registered in the first communication device and in the second communication device. The user may be registered in a Subscriber Identity Module of the first communication device and in a Subscriber Identity Module of the second communication device. The determining, as to whether one or more communication services provided in the communication session by the first communication device should be provided by the second communication device, may include reading a communication service provision rule file stored in at least one of the first communication device and the second communication device, and determining, as to whether one or more communication services provided in the communication session by the first communication device should be provided by the second communication device, using the read communication service provision rule file.

In various aspects of the disclosure, a device may be provided. The device may include a controller configured to carry out a method for providing a communication session. The method may include: establishing, during an established communication session between a first communication device and another communication device, a communication connection with a second communication device; determining, as to whether one or more communication services provided in the communication session by the communication device should be provided by the second communication device; and in case at least one of the communication services provided in the communication session should be provided by the second communication device, establishing a communication session connection for the at least one communication service of the communication session, and providing the at least one communication service by the second communication device within the established communication session.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for providing a communication session, the method comprising:
establishing, during an established communication session between a first communication device and another communication device, a communication connection with a second communication device;
determining, as to whether one or more communication services provided in the communication session by the first communication device should be provided by the second communication device; and
in case at least one of the communication services provided in the communication session should be provided by the second communication device, establishing a communication session connection for the at least one communication service of the communication session, and providing the at least one communication service by the second communication device within the established communication session.

2. The method of claim 1, further comprising:
determining device capabilities of the second communication device with respect to at least one communication service.

3. The method of claim 1,
wherein the at least one communication service is provided using one or more communication service parameters depending on the determined device capabilities of the second communication device.

4. The method of claim 1, further comprising:
discovering, during an established communication session between a first communication device and another communication device, a second communication device.

5. The method of claim 1, further comprising:
determining as to whether the second communication device is a trusted communication device, when a communication connection with the second communication device is possible; and
in case the second communication device is a trusted communication device, establishing the communication connection with the second communication device.

6. The method of claim 1, further comprising:
wherein the determining of device capabilities of the other communication device comprises reading the device capabilities from a stored device capability file.

7. The method of claim 1, further comprising:
wherein the determining of device capabilities of the second communication device comprises:
receiving a device capability message from the second communication device, and
determining the device capabilities from the device capability message.

8. The method of claim 7,
wherein the device capability message comprises a Session Initiation Protocol message.

9. The method of claim 1,
wherein the device capabilities with respect to a communication service comprise device capabilities with respect to the processing or outputting media data in accordance with a communication service.

10. The method of claim 1,
wherein the providing the at least one communication service by the second communication device comprises providing additional media types or less media types as provided in the initially established communication session.

11. The method of claim 1,
wherein establishing a communication connection with the second communication device comprises establishing a Local Area Network communication connection with the second communication device

12. The method of claim 1,
wherein the discovering the second communication device is carried out using an adhoc communication protocol discovering process.

13. The method of claim 1,
wherein the providing the at least one communication service by the second communication device within the established communication session comprises providing the at least one communication service using one or more communication service parameters dependent on the device capabilities of the second communication device with respect to the at least one communication service.

14. The method of claim 11,
wherein the establishing the Local Area Network communication connection with the second communication device comprises establishing a Wireless Local Area Network communication connection with the second communication device.

15. The method of claim 1,
wherein the establishing the communication connection with the second communication device comprises establishing a Personal Area Network communication connection with the second communication device.

16. The method of claim 14,
wherein the establishing the communication connection with the second communication device comprises establishing an adhoc communication network communication connection with the second communication device.

17. The method claim 1,
wherein a user is registered in the first communication device and in the second communication device.

18. The method of claim 17,
wherein the user is registered in a Subscriber Identity Module of the first communication device and in a Subscriber Identity Module of the second communication device.

19. The method of claim 1,
wherein the determining, as to whether one or more communication services provided in the communication session by the first communication device should be provided by the second communication device, comprises reading a communication service provision rule file stored in at least one of the first communication device and the second communication device, and
determining, as to whether one or more communication services provided in the communication session by the first communication device should be provided by the second communication device, using the read communication service provision rule file.

20. A device, comprising:
a controller configured to carry out a method for providing a communication session, the method comprising:
establishing, during an established communication session between a first communication device and another communication device, a communication connection with a second communication device;
determining, as to whether one or more communication services provided in the communication session by the communication device should be provided by the second communication device; and
in case at least one of the communication services provided in the communication session should be provided by the second communication device, establishing a communication session connection for the at least one communication service of the communication session, and providing the at least one communication service by the second communication device within the established communication session.
